(19) United States
(12) Patent Application Publication
(10) Pub. No.: US 2006/0215527 A1
(43) Pub. Date: Sep. 28, 2006

(54) Holographic recording medium and recording and reproducing apparatus

(75) Inventors: Akiyoshi Uchida, Kawasaki (JP); Toshikazu Kanaoka, Kawasaki (JP); Masakazu Taguchi, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 11/190,589

(22) Filed: Jul. 27, 2005

(30) Foreign Application Priority Data
Mar. 22, 2005 (JP) 2005-082081

(51) Int. Cl. G11B 7/00

(52) U.S. Cl. 369/103

(57) ABSTRACT

A holographic recording medium is a medium which records and reproduces data by irradiation with an information beam and a reference beam. This medium includes a user region for recording user data; and a calibration region for storing calibration data for calibrating an element which determines a recording and reproducing characteristic of a recording and reproducing apparatus for recording and reproducing data on/from the recording medium. The calibration data stored in the calibration region includes pattern information for measuring the element determining the recording and reproducing characteristic of the recording and reproducing apparatus.

### CROSS-REFERENCE TO RELATED APPLICATION

This application is related to Japanese patent application No. 2005-082081 filed on Mar. 22, 2005, whose priority is claimed under 35 USC § 119, the disclosure of which is incorporated by reference in its entirety.

### BACKGROUND OF THE INVENTION

1. Field of the Invention

The invention relates to a holographic recording medium and a recording and reproducing apparatus. More particularly, the invention relates to a medium and a recording and reproducing apparatus realizing improved reliability in recording and reproduction of data on/from a holographic recording medium capable of multiplexedly recording two-dimensional page data.

2. Description of the Related Art

As a medium capable of recording a large amount of information at high density, there is a holographic recording medium. The holographic recording medium is a medium capable of multiplexedly recording page data of an amount of hundreds megabytes in a single region. Holographic recording is performed by splitting a light beam from a single light source into a reference beam and an information beam, irradiating the same position on a recording medium with the reference beam and the information beam, changing the irradiation angle and wavelength of the reference beam to cause different interferences, and multiplexedly recording different information in the same position on the medium.

When the region in which the page data is multiplexedly recorded is irradiated only with the reference beam, a reproduction beam is generated. When the reproduction beam is detected by a two-dimensional page photodetector, one piece of page data is reproduced. The reproduction beam corresponds to one of a plurality of pieces of the multiplexedly recorded page data. For example, when the irradiation angle of the reference beam is changed, page data to be reproduced also changes. Alternatively, when the wavelength of the reference beam is changed, page data to be reproduced changes.

In the case of holographic recording, when the conditions (such as wavelength and irradiation angle) used at the time of recording and those used at the time of reproduction are the same, the page data recorded on a medium is reproduced. On the contrary, when the recording conditions and the reproduction conditions are different from each other, the page data is not reproduced at all or page data different from desired page data is reproduced.

Therefore, in holographic recording and reproduction, it is requested to eliminate variations in performances peculiar to a recording and reproducing apparatus, installation error of parts, and the like as much as possible and to satisfy standardized recording conditions and reproducing conditions with high precision.

It is, however, difficult to manufacture all of recording and reproducing apparatuses at the same precision. Existing recording media such as optical disks and holographic recording media are devised to maintain compatibility in consideration of variations peculiar to apparatuses (for example, Japanese Unexamined Patent Application No. 2004-69771 and Japanese Unexamined Patent Application No. 2000-293858).

Japanese Unexamined Patent Application No. 2004-69771 discloses a holographic system. In the case where there are a plurality of kinds of recording formats and in the case where there are individual differences among devices, reference data defining the formats or the like is prestored in a recording and reproducing apparatus. At the time of recording data on a medium side, reference data indicative of the recorded format and the like is recorded on the medium. At the time of reproducing data, reproduction data is corrected in consideration of the difference of reference data between the medium and the apparatus, thereby maintaining compatibility.

Japanese Unexamined Patent Application No. 2000-293858 discloses an optical reading medium on which recording and reproduction conditions (pulse condition, servo condition and the like) are preliminarily recorded. A recording and reproducing apparatus reads the recording and reproducing conditions, sets various conditions of the apparatus so as to satisfy the conditions, and records and reproduces information.

In the technique described in Japanese Unexamined Patent Application No. 2000-293858, numerical values of various conditions preliminarily recorded on a medium are read and necessary parameters are simply set in accordance with the conditions. Consequently, in the case where there is a problem in mechanical precision of an apparatus itself and the apparatus cannot operate according to the setting, an error may occur in a recording and reproducing process. When an error occurs, it is necessary to perform a learning process of changing the value of a parameter and obtaining an optimum condition adapted to the state of the apparatus.

In particular, in holographic recording and reproduction requiring a part used to have high precision, only by simply recording numerical values of various setting parameters on a medium, it is difficult to realize very reliable recording and reproduction.

In the holographic system described in Japanese Unexamined Patent Application No. 2004-69771, by correcting reproduction data on the basis of the reference data held in the apparatus and the reference data held in the medium, the original data is demodulated. However, the difference between the reference data is obtained and a performance error in the apparatus and medium is just corrected. The optimum condition in a combination of the apparatus and the medium is not always selected.

For example, even when irradiation angle information of the reference beam is preliminarily recorded on the medium and the apparatus, if there is no coincided angle information, it is not known how to determine the angle of irradiation of the reference beam. Even if angle information recorded on the medium is employed and the angle of irradiation is adjusted, since variations peculiar to the apparatus are not considered, there is a case that reproduction data cannot be obtained. Further, there is a case that a leaning process of adjusting the angle has to be performed. It is difficult to calibrate parts of each apparatus.

In the holographic recording and reproducing apparatus, in order to record and reproduce two-dimensional page data, a space modulator (SLM, DMD) and a two-dimensional image pickup device (CCD, CMOS) are used. Those optical parts are parts each having tens of thousands of pixels. It is difficult to always manufacture parts having no defect.

In an apparatus for mainly recording/reproducing an image such as a digital camera commercially available at present, even if a CCD has a pixel defect, the CCD is not regarded as a defective. Data in a defect position is corrected by using normal pixel data around the defect position. Even if the correction is insufficient, a human recognizes data as one picture, so that a problem hardly occurs.

On the other hand, in a holographic recording and reproducing apparatus for recording and reproducing document data including a character, a symbol and a numerical value, since data is random, it is difficult to make a correction. Since a defect can be corrected only by an ECC, if there is a defect in a CCD, there is a case that document data cannot be reproduced. Consequently, optical parts such as the CCD are requested to have percentage of completion of no defect much higher than that of a digital camera.

In order to manufacture a CCD and the like having no defect at high yield, a high-degree manufacturing technique is necessary, so that the cost increases.

Consequently, from the viewpoint of balance between manufacture cost and performance, on precondition that a part such as a CCD includes a defective element, it is desired to provide a holographic recording and reproducing apparatus in which even if a defective pixel that does not operate normally exists in a CCD or the like, it does not become a problem in practice.

That is, it is desired to grasp a defect in a CCD or the like included in an apparatus from the beginning and a defect which occurs after the apparatus is used, perform a process of regarding that the defects do not exist, and increase reliability of recording and reproduction.

### SUMMARY OF THE INVENTION

The invention provides a holographic recording medium provided for holographic recording and reproduction which records and reproduces data by irradiation with an information beam and a reference beam, comprising: a user region for recording user data; and a calibration region for storing calibration data for calibrating an element which determines a recording and reproducing characteristic of a recording and reproducing apparatus for recording and reproducing data on and from the recording medium, wherein the calibration data stored in the calibration region includes pattern information for measuring the element determining the recording and reproducing characteristic of the recording and reproducing apparatus.

According to the invention, since calibration data for calibrating an element of a recording and reproducing apparatus is recorded on a holographic recording medium, reliability of a holographic recording and reproducing process can be improved.

### BRIEF DESCRIPTION OF THE DRAWINGS

FIGS. 1A and 1B are diagrams illustrating a recording region of a holographic recording medium of the invention;

FIG. 2 is a diagram illustrating an example of calibration data of the invention;

FIG. 3 is a flowchart showing en example of a calibrating process of the invention;

FIGS. 4A and 4B are diagrams illustrating a case where a spatial light modulator of the invention has defects;

FIG. 5 is a diagram illustrating an example of a spatial light modulator having a spare data region of the invention;

FIG. 6 is a schematic diagram of a replacing process of the invention;

FIG. 7 is a diagram illustrating an example of the defect position information of the invention;

FIG. 8 is a diagram illustrating an example of the defect position information of the invention;

FIG. 9 is a diagram illustrating an example of apparatus adjustment information recorded on a medium of the invention;

FIG. 10 is a flowchart showing an example of an initializing process of a recording and reproducing apparatus of the invention;

FIG. 11 is a flowchart showing an example of a recording process of the recording and reproducing apparatus of the invention; and

FIG. 12 is a flowchart showing an example of a reproducing process of the recording and reproducing apparatus of the invention.

### DESCRIPTION OF THE PREFERRED EMBODIMENTS

An object of the invention is to provide a holographic recording medium and a recording and reproducing apparatus with improved reliability in recording and reproduction by recording calibration data for making recording and reproducing conditions of an apparatus optimum to the apparatus, defect information peculiar to each apparatus, and the like onto a medium.

In the holographic recording medium of the invention, the element which determines the recording and reproducing characteristic includes at least one of wavelength of the information beam or reference beam, an angle of incidence on a medium surface of the reference beam, and an area of a beam spot in the medium surface of the information beam or reference beam, and a plurality of pieces of pattern information having different recording and reproducing condition values by which reproduction characteristics preferable for the respective elements are obtained are stored in the calibration region.

Herein, the element which determines the recording and reproducing characteristic means, as described above, wavelength of the information beam or reference beam, an angle of incidence on a medium surface of the reference beam, an area of a beam spot in the medium surface of the information beam or reference beam, or the like. However, the invention is not limited thereto. If numerical values of the element are changed, the calibration data includes a plurality of pieces of pattern information exhibiting reproduction characteristics preferable for the respective different numeric values.

For example, in the case of thinking five different numerical values (m1 to m5) as numerical values of an element, calibration data including five pieces of pattern information is prepared. First pattern information P1 in the five pieces of pattern information corresponds to the numerical value m1 as one of the numerical values of the element. At the time of reproducing the first pattern information P1 when the numerical value of the element in a recording and reproducing apparatus is m1, a preferable reproduction characteristic is exhibited. However, if the first pattern information P1 is reproduced when the numerical value of the element in the apparatus is any of the other numerical values (m2 to m5), the reproduction characteristic deteriorates. The reproduction characteristic denotes the S/N ratio in reproduction. When there is no read error or the number of errors is relatively small at the time of reproduction of data, it denotes that the reproduction characteristic is preferable.

The pattern information is page data of a hologram recorded on a holographic recording medium. The pattern information may be known information and is not particularly specified. The pattern information is information accurately read when reproduced under the same conditions as those (wavelength of the reference beam, irradiation angle of the reference beam, and the like) of an element at the time of recording. For example, when pattern information is read at a wavelength different from that of recording, the S/N ratio is low, a number of errors occur, and the pattern information cannot be accurately read.

In the holographic recording medium of the invention, in the case of irradiating a region in which a piece of the pattern information is stored with a beam according to a specific recording and reproducing condition, the pattern information can be reproduced at an S/N ratio higher than that in the case of irradiating the region with a beam according to another recording and reproducing condition, and a plurality of pattern information of different specific recording and reproducing conditions are stored in the calibration region.

In the case where the calibration data includes a plurality of pieces of pattern information related to the wavelength of the information beam or reference beam, when a region in which a piece of pattern information is recorded is irradiated with a beam having a specific wavelength, the pattern information can be reproduced at an S/N ratio higher than that in the case of irradiating the area with a beam having other wavelengths. The plurality of pieces of pattern information may have specific wavelengths which are different from each other.

In the case where the element which determines the recording and reproducing characteristic is the wavelength of a reference beam, for example, five pieces of pattern information (P1 to P5) corresponding to five wavelengths (λ1 to λ5), respectively, are prepared. When the pattern information P1 corresponds to the wavelength λ1, the pattern information P1 is information recorded by the irradiation with a beam having the wavelength λ1. When irradiated with the beam having the wavelength λ1, an excellent reproducing characteristic of a high S/N ratio is exhibited. However, when irradiated with a beam having any of the other wavelengths (λ2 to λ5), a reproducing characteristic of a relatively low S/N ratio is exhibited.

The pattern information P5 corresponding to the wavelength λ5 is information recorded by the irradiation with a beam having the wavelength λ5. When irradiated with the beam having the wavelength λ5, the pattern information P5 can be reproduced at the highest S/N ratio. When irradiated with a beam having any of the other wavelengths (λ1 to λ4), the S/N ratio of reproduction is low, a number of errors occur, and the pattern information P5 cannot be read accurately.

In the invention, the plurality of pieces of pattern information may include: one pattern information which can be reproduced at the highest S/N ratio when reproduced with a beam having a first wavelength determined in a design specification, and “n” pieces of pattern information which can be reproduced at the highest S/N ratio when reproduced with a beam having any of “n” wavelengths which are different from the first wavelength only by predetermined values.

In addition, in order to reproduce the plurality of pieces of pattern information with higher reliability, these pieces of pattern information are preferably recorded at an S/N ratio higher than that of data recorded in the user region. A concrete recording method is a method of enhancing an exposure upon recording (for a long time with high output power) and intentionally lowering multiplex level of holographic recording.

In the holographic recording medium of the invention, the plurality of pieces of pattern information include pattern information which can be reproduced at the highest S/N ratio when reproduced with a first recording and reproducing condition determined in a design specification, and plural pieces of pattern information in which recording and reproducing conditions which allow reproduction at a high S/N ratio are made different from the first recording and reproducing condition by a predetermined value for the respective elements which determine the recording and reproducing characteristic.

Further, the plurality of pieces of pattern information are preferably recorded on different regions in the calibration region.

The medium of the invention further comprises a region for storing apparatus adjustment information indicative of a recording and reproduction condition peculiar to a recording and reproducing apparatus so as to be associated with user data recorded and reproduced by the recording and reproducing apparatus.

Herein, the apparatus adjustment information may include calibration result information, defect information of an optical part related to recording, and defect information of an optical part related to reproduction.

The invention also provides a recording and reproducing apparatus comprising: a beam emitter for generating an information beam and a reference beam from a single light source; a recording member for recording data by irradiating a holographic recording medium with the information beam and the reference beam generated by the beam emitter; a reproducing member for reproducing the data recorded on the medium by irradiating the holographic recording medium with the reference beam; and a calibrator for calibrating an element which determines a recording and reproducing characteristic of the recording member or reproducing member by using calibration data recorded on the holographic recording medium.

The beam emitter of the invention includes one light source such as a laser diode, a collimate lens for converting a light beam emitted from the light source into parallel light, a beam splitter for splitting the light beam emitted from the light source into an information beam component and a reference beam component, and the like. One of elements determining the recording and reproducing characteristic is the wavelength of a reference beam. Preferably, the beam emitter has a wavelength adjusting mechanism capable of changing the wavelength of the reference beam.

When the angle of irradiation of the reference beam is regarded as an element, it is preferable to provide an angle adjusting mechanism capable of changing the element, such as an actuator capable of changing the angle of a mirror for reflecting the reference beam toward a medium.

The recording member can be a spatial light modulator (SLM) and optical parts such as a beam splitter, a mirror and a convex lens. The reproducing member can be a two-dimensional image pickup device (CCD or CMOS) corresponding to a photodetector, and optical parts such as a beam splitter and a convex lens. Some of those parts can be commonly used.

When numerical values of elements which determine the recording and reproducing characteristic of the recording member or reproducing member are different from each other, the calibration data recorded on the holographic recording medium includes a plurality of pieces of pattern information indicative of preferable reproduction characteristics for the respective different numerical values, and the calibrator includes: a reproduction section for reproducing the plurality of pieces of pattern information; a comparator for comparing a numerical value A of an element corresponding to pattern information indicative of the most preferable reproduction characteristic as a result of the reproduction with a reference value A₀ of an element which is preset as a design specification of the recording and reproducing apparatus; and an element adjustor, when the numerical value A and the reference value A₀ do not coincide with each other as a result of the comparison, for adjusting the beam emitter, reproducing member or recording member so that the numerical value of the element corresponding to the pattern information exhibiting the most preferable reproducing characteristic becomes the reference value A₀.

The calibrator is a part for adjusting the beam emitter and the like so that an element having a numerical value peculiar to each recording and reproducing apparatus to have a reference value which is predetermined as a design specification. The reproduction section, comparator and element adjustor included in the calibrator are realized mainly by a microcomputer including a CPU, a ROM and a ROM.

The holographic recording medium may further comprise: a recording controller for reading apparatus adjustment information peculiar to each of different recording and reproducing apparatuses and preliminarily recorded on the holographic recording medium and, on the basis of the apparatus adjustment information peculiar to the apparatus, reconstructing user data so that the user data is correctly recorded on the medium; and a reproduction controller for reading the apparatus adjustment information recorded on the medium and identification information of a recording and reproducing apparatus which has recorded user data recorded on the medium from the medium and reconstructing reproduced user data on the basis of apparatus adjustment information peculiar to the recording and reproducing apparatus specified by the read identification information.

Further, the apparatus adjustment information peculiar to an apparatus may include information specifying a defect position in the recording member or reproducing member, the recording controller may include a replacement section for moving data to be recorded in the defect position to a predetermined spare data region on the basis of the information specifying the defect position, and the reproduction controller may include a replacement reverse section for reconstructing user data by moving back the data moved to the predetermined spare data region in reproduced data to the defect position on the basis of the information specifying the defect position.

Herein, the recording controller, reproduction controller, replacement section and replacement reverse section are realized mainly by a microcomputer, and the CPU operates hardware on the basis of a control program stored in the ROM or the like to execute the functions of functional blocks.

An element which determines the recording and reproducing characteristic may include any one of wavelength of the information beam or reference beam, an angle of incidence on a medium surface of the reference beam, and an area of a beam spot in the medium surface of the information beam or reference beam.

The recording member includes a space modulator for generating space information corresponding to user data to be recorded and modulating the information beam. A spatial light modulator (SLM) is a main part of the space modulator.

The reproducing member includes a photodetector for receiving a reproduction beam obtained by irradiating a medium with the reference beam.

Further, the recording member includes a space modulator for generating space information corresponding to user data to be recorded and modulating the information beam, the apparatus adjustment information peculiar to an apparatus includes information specifying a defect position in the space modulator, the space modulator has a user data region of user data and a spare data region including a replacement position in which data to be recorded in a defect position is saved, and when information specifying a defect position in the space modulator exists, the replacement section moves data to be recorded in the defect position to a spare position associated with the defect position.

Embodiments of the invention will be described below with reference to the drawings. The invention, however, is not limited to the description of the following embodiments.

<Holographic Recording Medium of the Invention>

In a holographic recording medium of the invention, user data supplied from a personal computer or the like is reconstructed as two-dimensional page data and is multiplexedly recorded on a holographic recording layer.

The holographic recording medium of the invention has a region for recording user data (hereinafter, referred to as user region) and a region for recording information for improving reliability of recording and reproduction (hereinafter, referred to as calibration region).

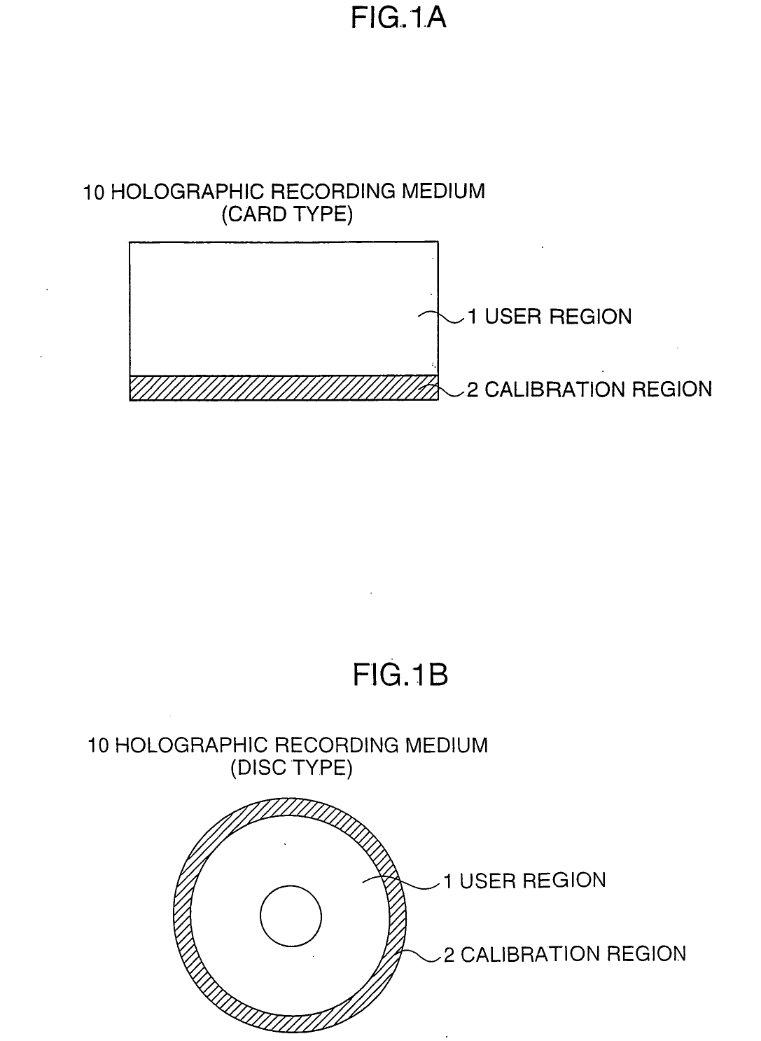

FIGS. 1A and 1B are diagrams illustrating a recording region in the holographic recording medium of the invention.

FIG. 1A is a plan view of a card-type medium 10 having a rectangular shape, and FIG. 1B is a plan view of a disc-type medium 10 having a circular shape. The shape of the medium 10 is not limited to those shapes. The medium 10 having another shape may be also designed.

In both of the media 10 of FIGS. 1A and 1B, a recording region is divided into a user region 1 and a calibration region 2. The two regions 1 and 2 do not have to be completely separated from each other. It is sufficient to specify the user region and the calibration region, and the user and calibration regions may exist mixedly.

In the user region 1, multimedia information in the form of so-called digital data such as a character, a symbol, a figure, an image and sound is recorded.

In the calibration region 2, “calibration data” and “apparatus peculiar information” as will be described later is recorded. Both of the information recorded on the regions are recorded as holographic data.

The “calibration data” denotes analog pattern information for setting the characteristic or parameter of a part in the recording and reproducing apparatus to be optimum. The calibration data is preliminarily recorded on a medium before shipment.

An example of the calibration data is pattern information for specifying the wavelength of a light beam emitted from a light source. The pattern information is holographic data including some pieces of page data.

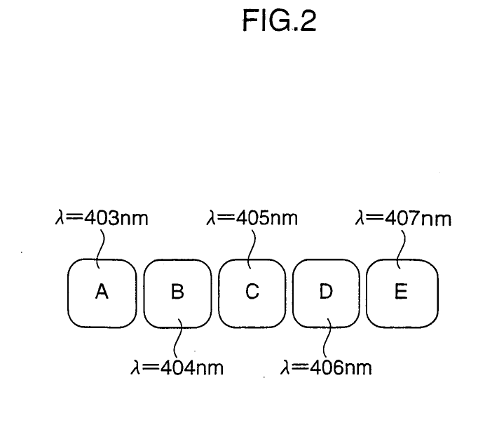

FIG. 2 is a diagram illustrating an example of the calibration data of the invention.

FIG. 2 shows a plurality of pieces of page data having various wavelengths of light beams. For example, page data recorded in a region A is pattern information which can be read at the highest S/N ratio when irradiated with a light beam having a wavelength (λ) of 403 nm. That is, the page data is not numerical data indicating that the wavelength (λ) is 403 nm but is pattern information. By reading the pattern information written in the region A, the wavelength (λ) of the emitted light beam can be specified as 403 nm. It can be therefore said that the pattern information is not digital numerical information such as a recording and reproducing condition in a conventional technique but is analog information for calibrating the wavelength.

From another viewpoint, the pattern information recorded in the region A is read by a light beam having a wavelength of 403 nm. When irradiated with a light beam having a wavelength which is not 403 nm (for example, 405 nm), the pattern information cannot be read at all or a number of reproduction errors occur.

Specifically, with the light beam having a specific wavelength (403 nm), no error occurs or, even if there is an error, the pattern information can be read at a very low error rate of a predetermined value or less. In contact, with a light beam having a wavelength other than the specific wavelength (403 nm), information which terribly deteriorates the S/N ratio is recorded.

Similarly, page data recorded in regions B, C, D and E is pattern information which can be read at the highest S/N ratio when irradiated with light beams having wavelengths (λ) of 404, 405, 406 and 407 nm, respectively.

It is preferable to record such calibration data by actually varying the wavelengths of light beams before shipment at the time of manufacture of a medium without multiplexing the calibration data.

By multiplexedly recording the calibration data in one region, a larger recording region of user data can be assured. However, the S/N ratio at the time of reproduction deteriorates, and accurate calibration may not be performed.

Since it is preferable to reproduce the calibration data at an S/N ratio as high as possible, the calibration data is recorded in different regions without being multiplexed. Alternatively, in the case of multiplexing the calibration data, the calibration data is recorded at a low degree of multiplexing.

By preliminarily recording a plurality of pieces of pattern information in a medium, irradiating regions with light beams, and detecting a region which can be reproduced at the lowest error rate, the wavelength of the light beam presently emitted can be specified. For example, when it is assumed that the pattern information in the region E can be reproduced at the lowest error rate, the wavelength of the light beam presently emitted can be specified as 407 nm. When the wavelength of the light beam of the light source provided for the apparatus is 407 nm in the case where the design specification is determined as 405 nm, user data on the medium recorded at the wavelength of 405 nm as the specification cannot be read or a number of errors occur. It is therefore understood that the wavelength of the light beam has to be adjusted.

Therefore, after that, by adjusting the wavelength of the light beam of the light source of the apparatus by using the pattern information of the region C corresponding to the design specification, the wavelength can be adjusted to the condition optimum to the apparatus itself.

FIG. 2 shows the regions (A to E) in which total five pieces of pattern information corresponding to the wavelength (405 nm) determined as the design specification and four wavelengths around the wavelength are recorded. The calibration data is not limited to the five pieces of pattern information. A larger number of pieces of pattern information may be recorded and units of varying the wavelength may be finer in accordance with the design specification and performance.

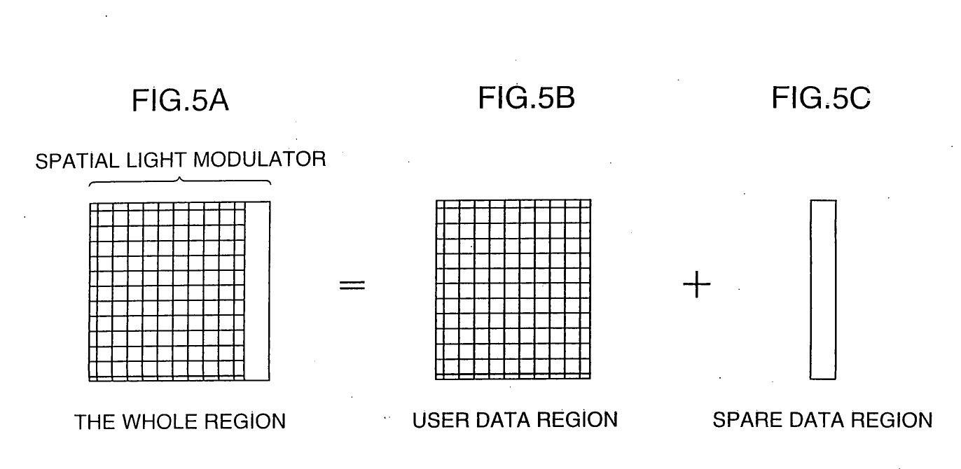

The five regions may be disposed so as to be adjacent to each other as shown in FIG. 5. The invention is not limited to the arrangement, and the five regions may be also disposed in arbitrary positions which are not neighboring to each other.

Examples of items of providing the calibration data other than wavelength are “tilt” and “focus” of a light beam.

“Tilt” denotes an angle of incidence on the medium surface of the reference beam at the time of performing angle multiplexing. Page data having different S/N ratios is preliminarily recorded in accordance with some angles of incidence. For example, in the case of performing angle multiplexing of five pieces of page data, it is sufficient to preliminarily record page data corresponding to the angles and some pieces of page data corresponding to angles slightly deviated from the angles so as not to be multiplexed or at a low degree of multiplexing. By using the plurality of pieces of page data, calibration is performed so that the angle of incidence of a reference beam becomes optimum.

“Focus” denotes an area in the surface of the medium of a beam spot of a light beam which is either the reference beam or information beam incident on the medium. Page data for adjusting the area of the beam spot to an optimum size according to the design is preliminarily recorded on the medium. It is sufficient to preliminarily record, for example, some pieces of page data which are reproduced at different S/N ratios for each area of the beam spot of a light beam without multiplexing the page data.

<Calibrating Process of the Invention>

An example of a calibrating process using the calibration data will now be described.

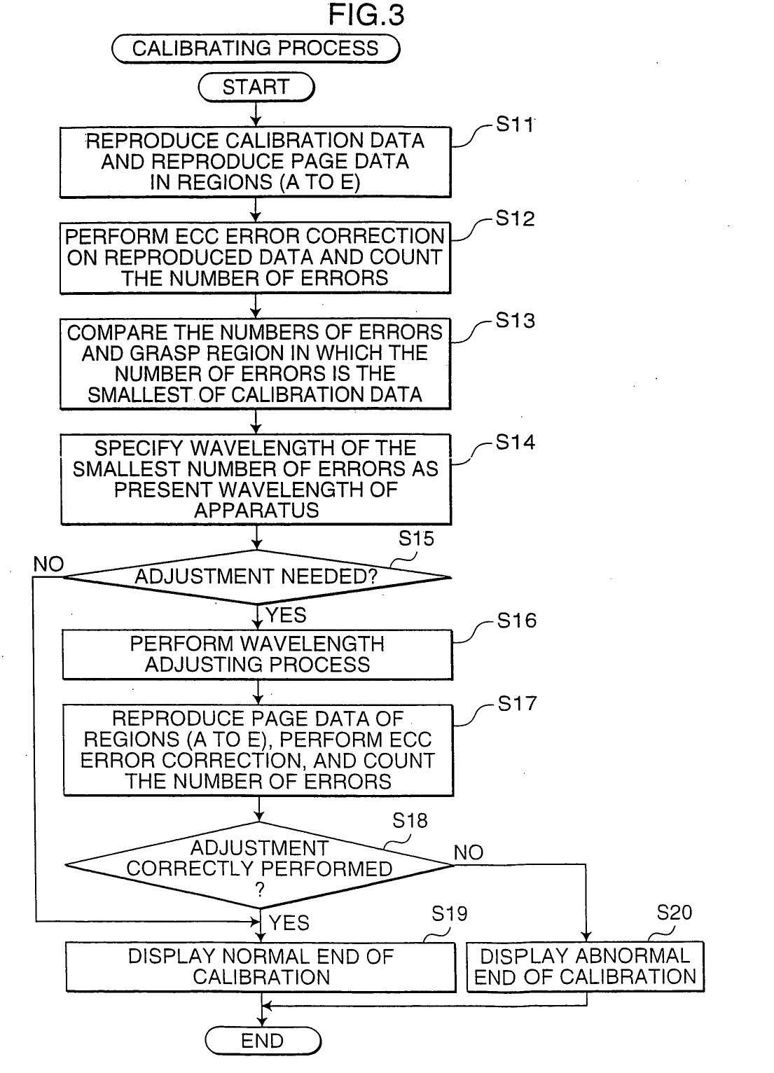

FIG. 3 shows a flowchart of an example of the calibrating process of the invention. Herein, the case where the five pieces of page data of FIG. 2 are preliminarily recorded on a medium and calibration is performed on the wavelength of a light source of the apparatus will be described. Whether the page data as shown in FIG. 2 is recorded on a medium or not may be checked by accessing a specific region when the medium is inserted in the apparatus and attempting reproduction of the data.

First, in step S11, calibration data preliminarily recorded on a medium is reproduced. For example, the page data in the five regions (A to E) is sequentially reproduced, and the reproduced data is temporarily stored.

Next, in step S12, on each of the five pieces of reproduction data, an error correcting process using an ECC is performed, and the number of errors (Ea, Eb, Ec, Ed and Ee) is counted. That is, the number of errors upon reproduction is evaluated for each of the regions, and the result of evaluation, that is, the number of errors (Ea to Ee) is temporarily stored.

In step S13, the numbers of errors in the five regions are compared with each other to grasp the region in which the number of errors is the smallest.

In step S14, the wavelength of the light source corresponding to the region of the smallest number of errors is selected, and the selected wavelength is specified as the present wavelength of the recording and reproducing apparatus. For example, in the case where the number Eb of reproduction errors in the page data in the region B is the smallest, the present wavelength (λ) of the apparatus is specified as 404 nm.

In step S15, whether adjustment of the wavelength is necessary or not is determined. In the case where the specified present wavelength is according to the design specification, steps S16 and S17 are unnecessary, and the program advances to step S19. In the other cases, the program advances to step S16.

In step S16, the wavelength of the light source of the apparatus is adjusted. When it is assumed that the wavelength of the light source which is set according to the specification is 405 nm, the wavelength of the light source of the apparatus is adjusted to become 405 nm. The wavelength is adjusted by, for example, changing the temperature of the environment of the light source.

When the present wavelength is 404 nm, by increasing the environment temperature only by a predetermined value, the wavelength can be changed to 405 nm.

In step S17, in order to check whether the adjustment has been normally performed or not, the processes similar to those in steps S11 and S12 are performed. Specifically, the page data in the regions A to E is reproduced by using a light beam having the adjusted wavelength, the number of ECC errors is counted, and whether the page data corresponding to the design specification could be reproduced at the highest S/N ratio or not is determined.

When the adjustment is performed correctly according to the design specification in step S18, the program advances to step S19. In other cases, the program advances to step S20.

In step S19, it is indicated that the calibrating process has been normally finished. In step S20, it is indicated that the normal calibrating process could not be executed. Steps S19 and S20 are not indispensable steps and may not be provided.

Such a calibrating process has to be performed also before shipment of the apparatus. A user who purchases the apparatus performs the calibrating process automatically each time the user who purchased the apparatus inserts the purchased medium into the apparatus or in response to an instruction input of the user. By performing the calibrating process each time a medium is inserted, the reliability of recording and reproducing operation of the recording and reproducing apparatus can be improved.

<Process of Replacing Defect in Recording and Reproducing Apparatus of the Invention>

Herein, an example of recording defect information of a recording and reproducing apparatus onto a medium in the case where when there is a defect in an optical part related to recording and reproducing operation of the recording and reproducing apparatus, so that normal recording and reproducing operation can be performed while the defect exists will be described.

Although a spatial light modulator as an optical part related to recording operation will be described as an example below, the invention is not limited to the example.

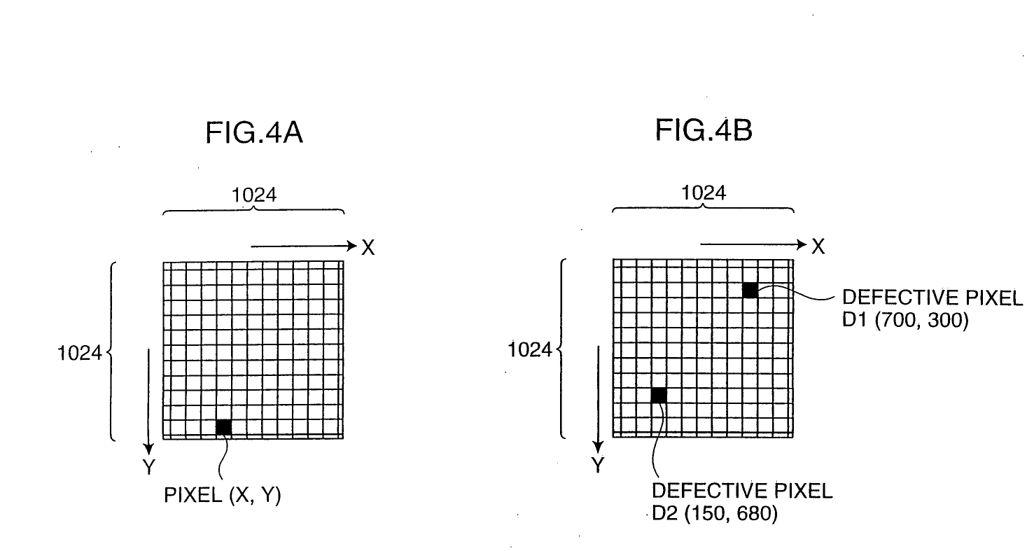

FIGS. 4A and 4B illustrate the case where a spatial light modulator (SLM) has defects.

FIG. 4A shows a spatial light modulator having pixels of 1,024 bits×1,024 bits. One pixel is specified by (X, Y) coordinates.

In FIGS. 4A and 4B, a lateral axis denotes an X axis, and a vertical axis denotes a Y axis.

FIG. 4B shows an example of the case where there are two defective pixels D1 and D2 in the spatial light modulator. It is assumed herein that the pixels D1 and D2 in positions of (X, Y)=(700, 300) and (150, 680), respectively, have defects, and data recorded via the two pixels cannot be normally recorded. Such a defect can be detected by recording and reproducing existing page data such as all of blank data, all of painted data or a specific pattern on/from a medium.

FIGS. 4A and 4B show only regions for recording user data, which are space regions corresponding to logic addresses given at the time of recording.

The spatial light modulator of the invention is characterized by having a spare data region in addition to the region (user data region) as shown in FIG. 4A.

FIGS. 5A to 5C are diagrams illustrating an example of the spatial light modulator having the spare data region of the invention.

The spatial light modulator of FIG. 5A includes a user data region (FIG. 5B) having pixels corresponding to logic addresses given from a high-order apparatus such as a personal computer and a spare data region (FIG. 5C) which does not correspond to a logic address.

It is sufficient to provide the spare data region in a position different from the space of recording user data, and the spare data region is not limited to the position shown in FIG. 5A. The area of the spare data region has to be assured in consideration of possibility of occurrence of defects. However, a necessary area cannot be unconditionally specified, so that a proper necessary area may be assured according to the design specification.

When the area of the spare data region is increased, even in the case where a number of defects occur, accurate recording and reproducing operation can be performed. However, a region of recording user data is narrowed, and recording capacity decreases. The spare data region is a region for moving the data D1 and D2 in the positions of the defects in the user data region. It is assumed that no defect exists in the repair data region.

Since data cannot be recorded by using the defect positions (D1 and D2) shown in FIG. 4B, original data to be recorded in the defect positions is moved to predetermined positions (spare positions) in the spare data region, and the original data is recorded in the spare positions in the spare data region.

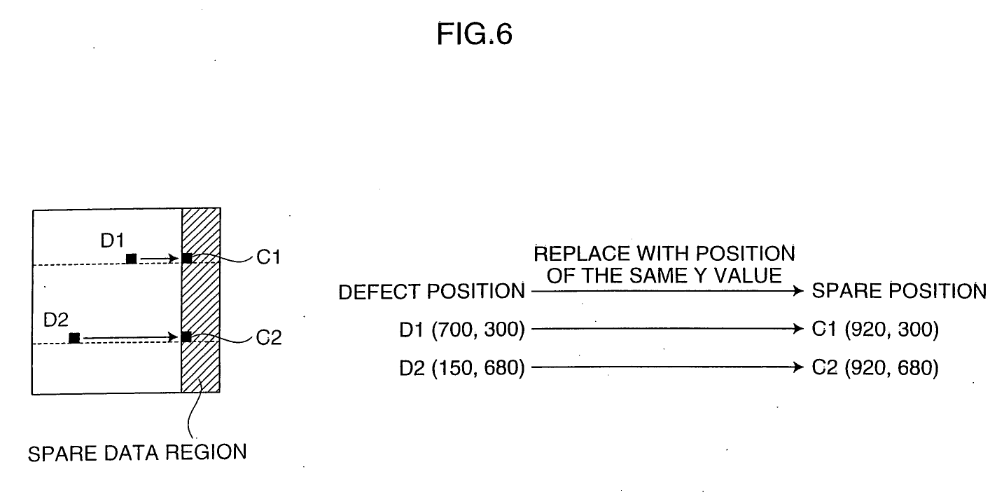

FIG. 6 is a schematic diagram showing a replacing process of the invention.

FIG. 6 shows an example of moving the data in the two defect positions (D1 and D2) to the spare data region in the same line. That is, the data is moved to a spare data region having the same Y coordinate as that of the defect position.

In FIG. 6, it is assumed that the spare data region exists at the X coordinates of 920 or larger.

For example, as shown in FIG. 6, data D1 (700, 300) is moved to a spare position C1 (920, 300), and data D2 (150, 680) is moved to a spare position C2 (920, 680). By the operation, data to be recorded in the defect positions D1 and D2 is recorded in the spare positions C1 and C2. Consequently, at the time of reproducing data originally recorded in the defect positions D1 and D2, a process of reproducing data recorded in the spare positions C1 and C2 and moving back the reproduced data to the defect positions is performed. In such a manner, normal reproduction can be performed.

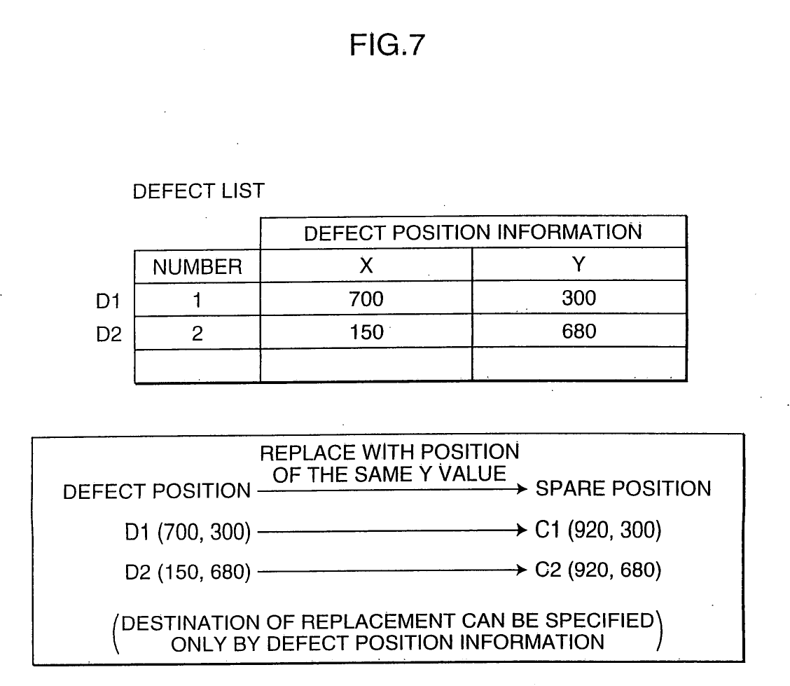

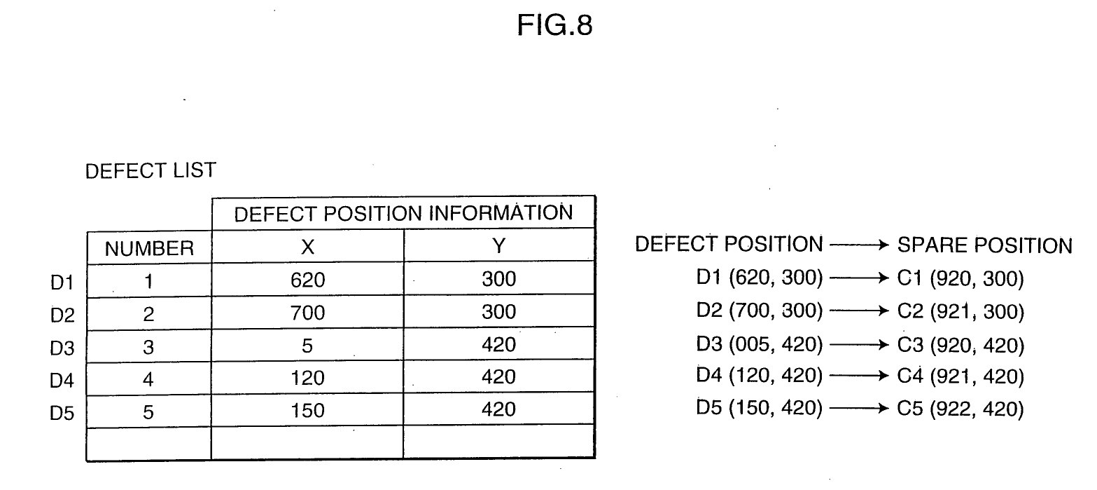

In order to perform such a replacing process, the defect position information (defect list) as shown in FIGS. 7 and 8 is stored in a recording memory in the apparatus and also stored in a specific region in the medium.

The specific region in the medium may be assured in an inner radius portion of a medium or the head or end of each of zones into which data is divided. Since the defect position information is important information, it is preferable to record the defect position information without multiplexing it.

In the defect list of FIG. 7, the coordinates of the two defect positions (D1, D2) shown in FIG. 4B are recorded.

As shown in FIG. 6, when the replacing process is performed under the rule of moving the data in the defect position to a spare data region having the same Y coordinate, only by storing the coordinates of the defect positions as shown in FIG. 7, the spare positions (C1, C2) can be specified. That is, it is unnecessary to store the coordinate data of the spare positions (C1, C2) in the spare data region, so that the data amount of the defect list can be suppressed.

FIG. 8 shows an example of a defect list of the case where a plurality of defects exist in the positions having the same Y coordinate in the user data region. In this case, for example, it is sufficient to assure a plurality of spare data regions having the same Y coordinate.

FIG. 8 shows that data to be recorded in two defect positions (620, 300) and (700, 300) having the same Y coordinate are moved to spare positions (920, 300) and (921, 300) having the same Y coordinate, respectively.

Considering the case as shown in FIG. 8, it is necessary to preliminarily assure a plurality of spare positions for each of lines in the spare data region. However, data is moved to a spare position having the same Y coordinate as that of the defect position, so that the data amount of the defect list can be suppressed.

The replacing process shown in FIG. 6 is an example, and the invention is not limited to the process. Alternatively, a defect position may be associated with a spare position from the head of the spare data region in the order in which defects occurs.

<Apparatus Adjustment Information of the Invention>

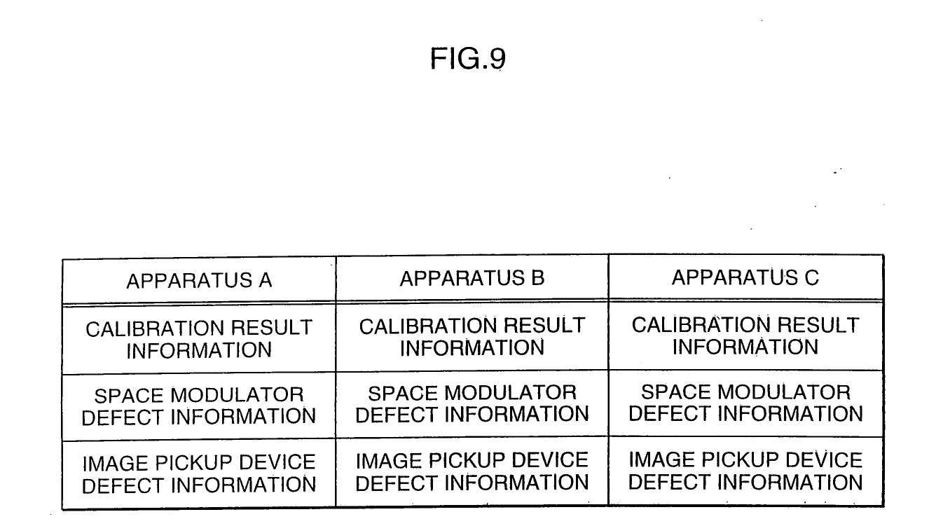

An example of information to be recorded on a medium (apparatus adjustment information) of the invention will be described with reference to FIG. 9. In this case, a holographic recording medium is a portable medium which can be inserted to the recording and reproducing apparatus of the invention, and is a medium which can be inserted to a number of recording and reproducing apparatuses and on/from which information can be recorded and reproduced.

Information shown in FIG. 9 is apparatus adjustment information indicative of recording and reproducing conditions peculiar to a recording and reproducing apparatus and recorded for each apparatus to which a medium is inserted. The apparatus adjustment information indicative of the recording and reproducing conditions peculiar to the recording and reproducing apparatus is information indicative of a concrete recording and reproducing condition in configuration of the apparatus in relation with the recording medium inserted in the apparatus. For example, when the medium is inserted in an apparatus A of the invention, result information of a calibrating process performed by the apparatus A, defect position information (defect list) of the spatial light modulator already detected by the apparatus A, and defect position information (defect list) of an image pickup device already detected by the apparatus A is recorded. As the configuration of recording the apparatus adjustment information, a configuration of recording, as the apparatus adjustment information, only the difference between a design specification properly set at the time of manufacture and a concrete recording and reproducing condition of an individual apparatus may be employed.

The result information of the calibrating process denotes numerical information such as the wavelength (λ) before calibration of the apparatus A, temperature condition and parameter changed at the time of calibrating the wavelength, the angle (tilt) before calibration, and a condition necessary for angle adjustment.

The defect position information of the spatial light modulator and the image pickup device denotes a defect list as shown in FIGS. 7 and 8. Also in the case where a medium is inserted in apparatus B or C different from the apparatus A, similarly, three kinds of information of FIG. 9 are recorded. The apparatus adjustment information is not limited to the three kinds of information. The apparatus adjustment information may be updated not only when a medium is inserted into the apparatus but may be updated immediately after the calibrating process or a defect diagnosing process is performed, or may be updated periodically (once a day or upon power-on).

At the time of recording user data onto the medium by using the apparatus A, apparatus identification information indicating that the user data is recorded by the apparatus A is recoded in a specific region of page data in which the user data is recorded. Also in the case of recording user data by using the apparatus B or C, similarly, the apparatus identification information of the apparatus B or C is recorded in a specific region of page data in which the user data is recorded.

As described above, by recording the apparatus adjustment information and the apparatus identification information as shown in FIG. 9 onto a medium, in the case of using the medium by inserting it into a plurality of apparatuses, the user data recorded by another apparatus can be reproduced with higher reliability.

Information (page number and apparatus identification information) indicating page data recorded and an apparatus which has recorded the page data may be recorded in a lump in the apparatus adjustment information shown in FIG. 9.

For example, a case of inserting a medium on which user data Data1 is recorded by the apparatus A having a defect as shown in FIG. 7 into an apparatus B having no defect and reproducing the user data Data1 will be considered. Since the defect position information of the apparatus A is recorded on the medium, when the information of FIG. 9 recorded on the medium is read in the apparatus B, the user data Data1 recorded by the apparatus A is subjected to the replacing process on the defect position of the apparatus A. Therefore, by performing the process of moving back the data in the spare position to the defect position by a process reverse to the replacing process, the user data Data1 can be moved back normally.

Concrete processes including the replacing process of the invention will now be described.

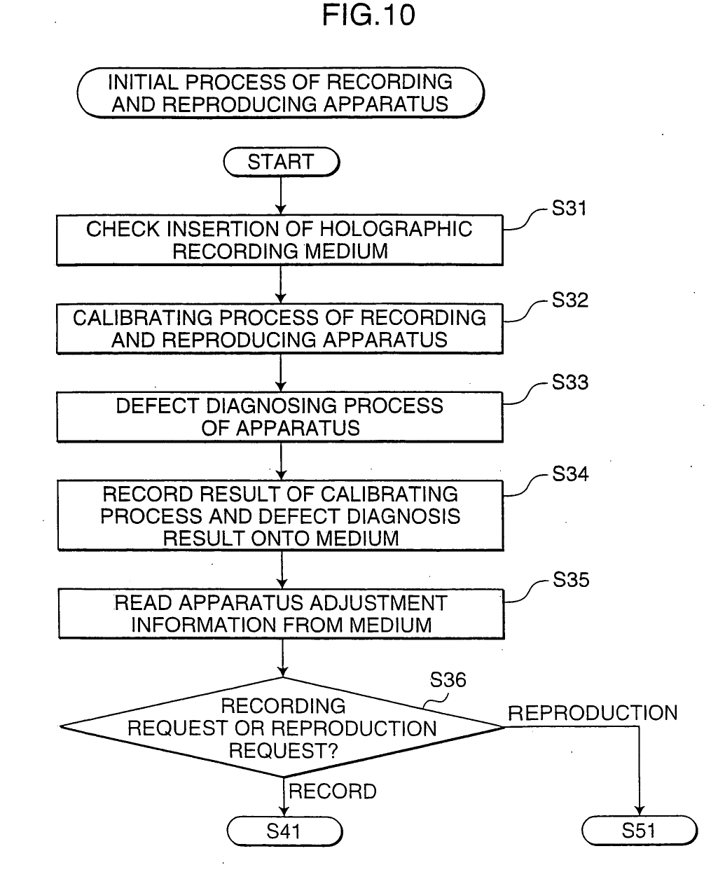

FIG. 10 shows a flowchart of an example of an initial process of the recording and reproducing apparatus of the invention.

First, in step S31, whether a holographic recording medium is inserted in the recording and reproducing apparatus of the invention or not is checked. It is sufficient to perform the checking process by turning on/off a physical switch or by software in a manner similar to that in a conventional optical disk drive or the like. After insertion of the medium is recognized, the program advances to process in step S32 and subsequent steps.

In step S32, a calibrating process of the apparatus is executed. The calibrating process is performed in the flow as shown in FIG. 3 by using the calibration data recorded on the inserted medium. For example, when the wavelength of the light source of the apparatus is different from the specification, a predetermined adjusting process is executed so that the wavelength coincides with the specification.

In step S33, a defect diagnosing process of the apparatus is executed. Whether or not there is a defect in the space modulator or an image pickup device is determined. In the case where there is a defect, the defect position is specified, and the position information is recorded on the memory. The process is not an indispensable process at this stage. It is sufficient to perform the process at least upon initial setting or power-on of the apparatus.

Since the space modulator deteriorates according to use and there is a case that a defect occurs or the number of defects increases, in order to increase the reliability, the defect diagnosing process on the apparatus may be performed at the time of a recording request or a reproduction request.

In step S34, the apparatus adjustment information (see FIG. 9) including result information (wavelength data before diagnosis, adjustment condition and the like before diagnosis) of the calibrating process in step S32 and diagnosis result in step S33 (defect position information) is recorded in a specific region of the medium. The information is recorded on a medium for each apparatus. In order to assure high reliability, when there are a plurality of apparatuses, the recording is performed at a high S/N ratio, that is, without being multiplexed or with the low degree of multiplexing. Alternatively, in order to assure higher reliability, it is also possible to record the same information in a plurality of different regions, read the plurality of information, and reproduce information by a majority.

In step S35, all of the apparatus adjustment information recorded on the medium including the apparatus adjustment information recorded on the medium in step S34 and the apparatus adjustment information already recorded before step S34 is read. For example, as shown in FIG. 9, in the case where the apparatus adjustment information of the three apparatuses (A, B and C) is recorded on the medium, all of the three kinds of information is read.

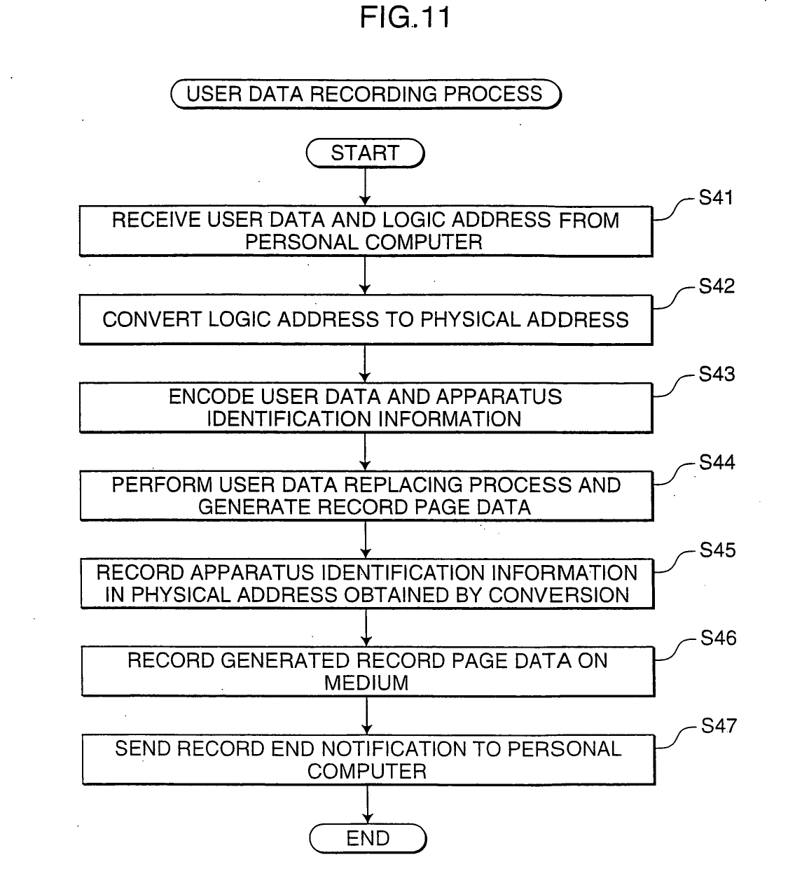

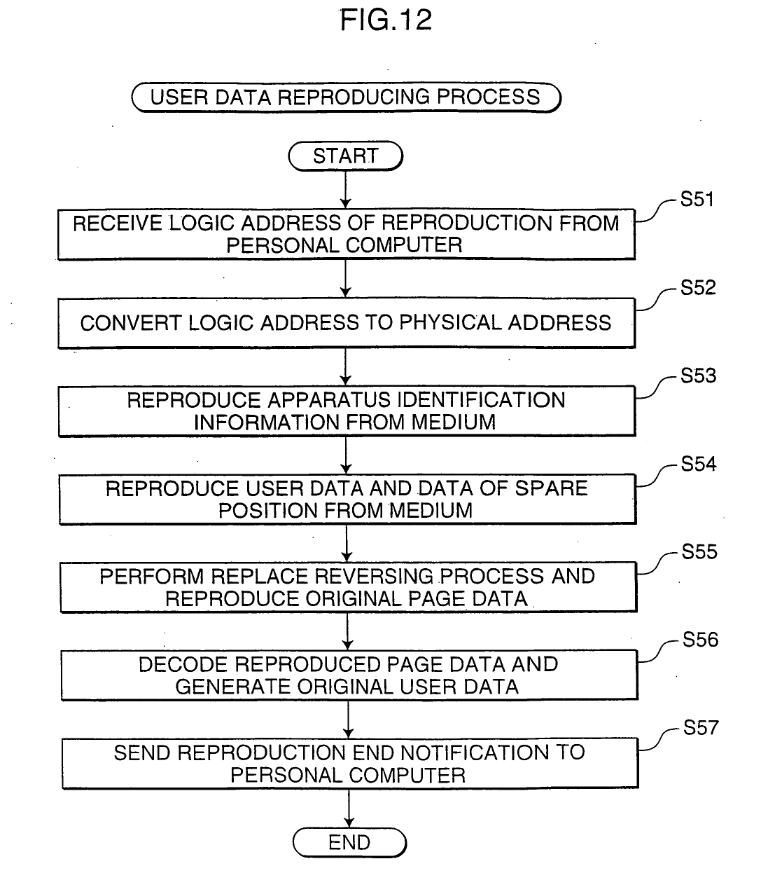

In step S36, a check is made to see whether or not a request for recording user data or a reproduction request is sent from a high-order apparatus such as a personal computer. If there is a recording request, the program advances to step S41 (see FIG. 11). If there is a reproduction request, the program advances to step S51 (see FIG. 12).

The above processes are executed by a microcomputer provided for the recording and reproducing apparatus of the invention. The microcomputer has a CPU, a ROM, a RAM, an I/O controller, a timer and the like. The CPU organically operates the hardware on the basis of a control program recorded on the ROM or the like, thereby realizing the various functions of the apparatus.

FIG. 11 shows a flowchart of an example of the recording process of the invention. It is also assumed herein that a defect exists in the spatial light modulator.

In step S41, user data to be recorded and a logic address in which the user data is to be recorded are received from a high-order apparatus such as a personal computer.

In step S42, the received logic address is converted to a physical address corresponding to the position on the medium.

In step S43, the apparatus identification information preliminarily recorded on the memory of the apparatus is read, the user data and the apparatus identification information are coded, and an error correction code such as an ECC is added.

In step S44, the defect position information of the spatial light modulator is read from the memory of the apparatus, and the user data replacing process is performed. Specifically, a defect position is specified from the read defect position information, and user data to be recorded in the defect position is extracted. The extracted user data is moved to a predetermined spare position. In such a manner, page data (see FIG. 5) including the user data region and the spare data region and to be recorded on a medium is generated. The page data to be recorded is supplied to the space modulator.

In step S45, the apparatus identification information is recorded in the position of a physical address in the medium obtained by address conversion.

In step S46, page data including data of the spare position is recorded on the medium.

In step S47, a recording end notification is transmitted to a personal computer or the like. The personal computer or the like receives the notification and may perform a so-called verifying process of checking whether recording has been normally performed or not.

The above is the processes of performing the replacing process when the spatial light modulator has a defect and recording user data onto a medium. When the spatial light modulator does not have a defect, it is unnecessary to perform the replacing process of step S44.

FIG. 12 shows a flowchart of an example of the reproducing process of the invention.

In step S51, a logic address to be reproduced is received from a high-order apparatus such as a personal computer.

In step S52, the received logic address is converted to a physical address.

In step S53, the apparatus identification information recorded in the physical address obtained by conversion on the medium is reproduced. By the operation, the apparatus which has recorded the page data recorded in the physical address to be reproduced is known.

In step S54, page data including the user data region and the spare region is read from a medium, and the reproduced page data is temporarily stored in the memory.

In step S55, an operation reverse to the replacing process is performed by using a defect list in the apparatus adjustment information read in step S35 in FIG. 10, thereby generating the original page data. For example, when there is a defect list of the space modulator in the apparatus adjustment information, data recorded in the spare position is read and recorded back to the corresponding defect position.

In step S56, ECC error correction decoding is performed on the reproduction page data in which the data in the defect position is moved back, thereby generating the original user data.

In step S57, a reproduction end notification is transmitted to a personal computer or the like.

As described above, page data subjected to the replacing process considering a defect in the apparatus is recorded on a medium. The page data is read from the medium. After that, a process reverse to the replacing process is performed in consideration of a defect of an apparatus which has recorded the page data, thereby reproducing the user data. Consequently, the user can perform very reliable recording and reproducing operation without concerning defects in an apparatus at all even in the case where there is a defect in the apparatus from the beginning or the case where a defect occurs or the number of defects increases in use.

According to the invention, since calibration data for calibrating an element of a recording and reproducing apparatus is recorded on a holographic recording medium, reliability of a holographic recording and reproducing process can be improved.

Since an element of a recording and reproducing apparatus is calibrated with calibration data, reliability of a recording and reproducing process on a holographic recording medium can be improved.

Further, by recording apparatus adjustment information including defect information specifying a defect position in an optical part onto a holographic recording medium, reliability of a recording and reproducing process can be further improved.

What is claimed is:

1. A holographic recording medium provided for holographic recording and reproduction which records and reproduces data by irradiation with an information beam and a reference beam, comprising:
a user region for recording user data; and
a calibration region for storing calibration data for calibrating an element which determines a recording and reproducing characteristic of a recording and reproducing apparatus for recording and reproducing data on/from the recording medium, wherein
the calibration data stored in the calibration region includes pattern information for measuring the element determining the recording and reproducing characteristic of the recording and reproducing apparatus.

2. The holographic recording medium of claim 1, wherein
the element which determines the recording and reproducing characteristic includes at least one of wavelength of the information beam or reference beam, an angle of incidence on a medium surface of the reference beam, and an area of a beam spot in the medium surface of the information beam or reference beam, and
a plurality of pieces of pattern information having different element values by which reproduction characteristics preferable for the respective elements are obtained are stored in the calibration region.

3. The holographic recording medium of claim 1, wherein
a plurality of pieces of pattern information related to wavelength of the information beam or reference beam are stored in the calibration region,
in the case of irradiating a region in which a piece of the pattern information is stored with a beam having a specific wavelength, the pattern information can be reproduced at an S/N ratio higher than that in the case of irradiating the region with a beam having another wavelength, and
a plurality of pattern information of different specific wavelengths are stored in the calibration region.

4. The holographic recording medium of claim 1, wherein
a plurality of pieces of pattern information related to an angle of incidence of the reference beam are stored in the calibration region,
in the case of irradiating a region in which a piece of the pattern information is stored with a beam having a specific angle of incidence, the pattern information can be reproduced at an S/N ratio higher than that in the case of irradiating the region with a beam having another angle of incidence, and
a plurality of pattern information of different specific angles of incidence are stored in the calibration region.

5. The holographic recording medium of claim 1, wherein
a plurality of pieces of pattern information related to an area of a beam spot of the information beam or reference beam are stored in the calibration region,
in the case of irradiating a region in which a piece of the pattern information is stored with a beam having a specific beam spot area, the pattern information can be reproduced at an S/N ratio higher than that in the case of irradiating the region with a beam having another beam spot area, and
a plurality of pattern information of different specific beam spot areas are stored in the calibration region.

6. The holographic recording medium of claim 3, wherein
the plurality of pieces of pattern information include:
one pattern information which can be reproduced at the highest S/N ratio when reproduced with a beam having a first wavelength determined in a design specification, and
“n” pieces of pattern information which can be reproduced at the highest S/N ratio when reproduced with a beam having any of “n” wavelengths which are different from the first wavelength only by predetermined values.

7. The holographic recording medium of claim 4, wherein
the plurality of pieces of pattern information include:
one pattern information which can be reproduced at the highest S/N ratio when reproduced with a beam having a first incidence angle determined in a design specification, and
“n” pieces of pattern information which can be reproduced at the highest S/N ratio when reproduced with a beam having any of “n” incidence angles which are different from the first incidence angle only by predetermined values.

8. The holographic recording medium of claim 5, wherein
the plurality of pieces of pattern information include:
one pattern information which can be reproduced at the highest S/N ratio when reproduced with a beam having a first beam spot area determined in a design specification, and
“n” pieces of pattern information which can be reproduced at the highest S/N ratio when reproduced with a beam having any of “n” beam spot areas which are different from the first beam spot area only by predetermined values.

9. The holographic recording medium of claim 2, wherein
the plurality of pieces of pattern information are recorded at an S/N ratio higher than that of data recorded on the user region.

10. The holographic recording medium of claim 2, wherein
the plurality of pieces of pattern information are stored in different regions in the calibration region.

11. The holographic recording medium of claim 1, further comprising:
a region for storing apparatus adjustment information indicative of a recording and reproduction condition peculiar to a recording and reproducing apparatus so as to be associated with user data recorded and reproduced by the recording and reproducing apparatus.

12. The holographic recording medium of claim 11, wherein
the region for storing the apparatus adjustment information includes at least one of calibration result information, defect information of an optical part related to recording, and defect information of an optical part related to reproduction.

13. A recording and reproducing apparatus comprising:
a beam emitter for generating an information beam and a reference beam from a single light source;
a recording member for recording data by irradiating a holographic recording medium with the information beam and the reference beam generated by the beam emitter;
a reproducing member for reproducing the data recorded on the medium by irradiating the holographic recording medium with the reference beam; and
a calibrator for calibrating an element which determines a recording and reproducing characteristic of the recording member or reproducing member by using calibration data recorded on the holographic recording medium.

14. The recording and reproducing apparatus of claim 13, wherein
when numerical values of elements which determine the recording and reproducing characteristic of the recording member or reproducing member are different from each other, the calibration data recorded on the holographic recording medium includes a plurality of pieces of pattern information indicative of preferable reproduction characteristics for the respective different numerical values, and
the calibrator includes:
a reproduction section for reproducing the plurality of pieces of pattern information;
a comparator for comparing a numerical value A of an element corresponding to pattern information indicative of the most preferable reproduction characteristic as a result of the reproduction with a reference value A₀ of an element which is preset as a design specification of the recording and reproducing apparatus; and
an element adjustor, when the numerical value A and the reference value A₀ do not coincide with each other as a result of the comparison, for adjusting the beam emitter, reproducing member or recording member so that the numerical value of the element corresponding to the pattern information exhibiting the most preferable reproducing characteristic becomes the reference value A₀.

15. The recording and reproducing apparatus of claim 13, further comprising:
a recording controller for reading apparatus adjustment information peculiar to each of different recording and reproducing apparatuses and preliminarily recorded on the holographic recording medium and, on the basis of the apparatus adjustment information peculiar to the apparatus, reconstructing user data so that the user data is correctly recorded on the medium; and
a reproduction controller for reading the apparatus adjustment information recorded on the medium and identification information of a recording and reproducing apparatus which has recorded user data recorded on the medium from the medium and reconstructing reproduced user data on the basis of apparatus adjustment information peculiar to the recording and reproducing apparatus specified by the read identification information.

16. The recording and reproducing apparatus of claim 15, wherein the apparatus adjustment information peculiar to an apparatus includes information specifying a defect position in the recording member or reproducing member,
the recording controller includes a replacement section for moving data to be recorded in the defect position to a predetermined spare data region on the basis of the information specifying the defect position, and
the reproduction controller includes a replacement reverse section for reconstructing user data by moving back the data moved to the predetermined spare data region in reproduced data to the defect position on the basis of the information specifying the defect position.

17. The recording and reproducing apparatus of claim 16, wherein the recording member includes a space modulator for generating space information corresponding to user data to be recorded and modulating the information beam,
the apparatus adjustment information peculiar to an apparatus includes information specifying a defect position in the space modulator,
the space modulator has a user data region of user data and a spare data region including a replacement position in which data to be recorded in a defect position is saved, and
when information specifying a defect position in the space modulator exists, the replacement section moves data to be recorded in the defect position to a spare position associated with the defect position.

18. The recording and reproducing apparatus of claim 13, wherein an element which determines the recording and reproducing characteristic includes at least one of wavelength of the information beam or reference beam, an angle of incidence on a medium surface of the reference beam, and an area of a beam spot in the medium surface of the information beam or reference beam.

19. The recording and reproducing apparatus of claim 13, wherein the recording member includes a space modulator for generating space information corresponding to user data to be recorded and modulating the information beam.

20. The recording and reproducing apparatus of claim 13, wherein the reproducing member includes a photodetector for receiving a reproduction beam obtained by irradiating a medium with the reference beam.
